(19) United States
(12) Patent Application Publication
(10) Pub. No.: US 2018/0359044 A1
(43) Pub. Date: Dec. 13, 2018

(54) TRANSMISSION OF SYNCHRONIZATION INFORMATION

(71) Applicant: NOKIA SOLUTIONS AND NETWORKS OY, Espoo (FI)

(72) Inventors: Juho Mikko Oskari Pirskanen, Kangasala (FI); Tero Johannes Ihalainen, Nokia (FI); Toni Levanen, Tampere (FI)

(21) Appl. No.: 15/780,598

(22) PCT Filed: Dec. 1, 2015
(86) PCT No.: PCT/EP2015/078192

§ 371 Date: May 31, 2018

(51) Int. Cl. H04J 11/00; H04L 5/00; H04B 7/06; H04W 48/16; H04W 48/08

(52) U.S. Cl. CPC H04J 11/0069; H04L 5/0051; H04W 48/08; H04W 48/16; H04B 7/0617

(57) ABSTRACT

Transmission of synchronization information Access information is transmitted at a repetition interval by replacing one or more downlink symbols belonging to a specific port with one or more sequences of the synchronization information. The replaced downlink symbol may be a demodulation reference symbol or a downlink data symbol.

### TECHNICAL FIELD

The invention relates to wireless communications in a cellular communication system and, in particular, to access information.

### BACKGROUND

Cell detection and cell synchronization are first steps when a terminal device wants to connect to a cell in a wireless system. Access nodes of modern fourth generation cellular systems broadcast periodically access information, for example a primary synchronization signal (PSS) and a secondary synchronization signal (SSS) on fixed physical layer resources, to enable terminal devices to detect a cell provided by an access node and be synchronized to the cell with certain delay, accuracy and reliability. With the emergence of the next generation of the cellular systems other requirements, even contradicting requirements, are to be seen. They create further requirements to the cell detection and synchronization procedure.

### BRIEF DESCRIPTION

According to an aspect, there is provided the subject matter of the independent claims. Some embodiments are defined in the dependent claims.

One or more examples of implementations are set forth in more detail in the accompanying drawings and the description below. Other features will be apparent from the description and drawings, and from the claims.

### BRIEF DESCRIPTION OF DRAWINGS

In the following embodiments will be described in greater detail with reference to the attached drawings, in which

FIG. 1 illustrates an exemplified wireless communication system;

FIG. 2 illustrates an exemplified radio architecture;

FIG. 3 illustrates an exemplified process;

FIGS. 4 to 11 illustrate exemplified allocation examples;

FIG. 12 illustrates an exemplified procedure;

FIGS. 13A to 13D illustrates different time-frequency allocation examples;

FIGS. 14 to 16 illustrate exemplified processes;

FIG. 17 illustrates an exemplified beam-formed transmissions at different times; and

FIGS. 18 and 19 are schematic block diagrams.

### DETAILED DESCRIPTION OF SOME EMBODIMENTS

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

Embodiments described herein may be implemented in a wireless system, such as in at least one of the following: Universal Mobile Telecommunication System (UMTS, 3G) based on basic wideband-code division multiple access (W-CDMA), high-speed packet access (HSPA), Long Term Evolution (LTE), LTE-Advanced, 5G system, beyond 5G, and/or wireless local area networks (WLAN), such as Wi-Fi. The embodiments are not, however, restricted to the system given as an example but a person skilled in the art may apply the solution to other communication systems provided with necessary properties. One example of a suitable communications system is the 5G system, as listed above.

5G is likely to use active antenna system (AAS) with horizontal and vertical beam control, multiple-input-multiple-output (MIMO) multi-antenna transmission techniques, many more base stations or access nodes than the current network deployments of LTE (a so-called small cell concept), including macro sites operating in co-operation with smaller local area access nodes and perhaps also employing a variety of radio technologies for better coverage and enhanced data rates. 5G will likely be comprised of more than one radio access technology (RAT), each optimized for certain use cases and/or spectrum. 5G mobile communications will have a wider range of use cases and related applications including video streaming, augmented reality, different ways of data sharing and various forms of machine type applications, including vehicular safety, different sensors and real-time control. 5G is expected to have multiple radio interfaces, namely interfaces for frequency ranges below 6 GHz, cmWave frequency ranges ranging from 3GHz to 30 GHz, mmWave frequency ranges ranging from 30 GHz to 100 GHz, and/or for even higher frequencies, and also being integrated and/or interoperate with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz-cmWave, below 6 GHz-cmWave-mmWave). One of the concepts considered to be used in 5G networks is network slicing in which multiple independent and dedicated virtual sub-networks (network instances) may be created within the same infrastructure to run services that have different requirements on latency, reliability, throughput and mobility.

Further, 5G is likely to have rather stringent and somewhat diversified aims/requirements to the cell detection and synchronization procedure. One aim is naturally to reduce the delay of the cell detection and synchronization with improved accuracy and reliability. The cell detection and synchronization procedure should support efficient cell discontinuous transmission (DTX). Naturally the procedure should support different deployments and services, such as low power machine-type communications (MTC), mobile broadband and ultra reliable communications. A still further requirement is to support advanced antenna solutions (AAS) and beamforming for synchronization and control information to improve cell coverage.

It should be appreciated that future networks will most probably utilize network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or cloud data storage may also be utilized. In radio communications this may mean node operations to be carried out, at least partly, in a server, host or node operationally coupled to a remote radio head. It is also possible that node operations will be distributed among a plurality of servers, nodes or hosts. It should also be understood that the distribution of labor between core network operations and base station operations, and terminal device operations may differ from that of the LTE or even be non-existent. Some other technology advancements probably to be used are Software-Defined Networking (SDN), Big Data, and all-IP, which may change the way networks are being constructed and managed. For example, one or more of the below described network node functionalities may be migrated to any corresponding abstraction or apparatus. Therefore, all words and expressions should be interpreted broadly and they are intended to illustrate, not to restrict, the embodiment.

Below different examples are described assuming a frame based system having radio resources wireless resources, without restricting the embodiments thereto. It is a straightforward process for one skilled in the art to apply the teachings to a non-frame based, such as a load-based system. A frame based system may use time division duplexing (TDD) and/or frequency division duplexing (FDD), and the system may be a full duplex system or a half duplex system.

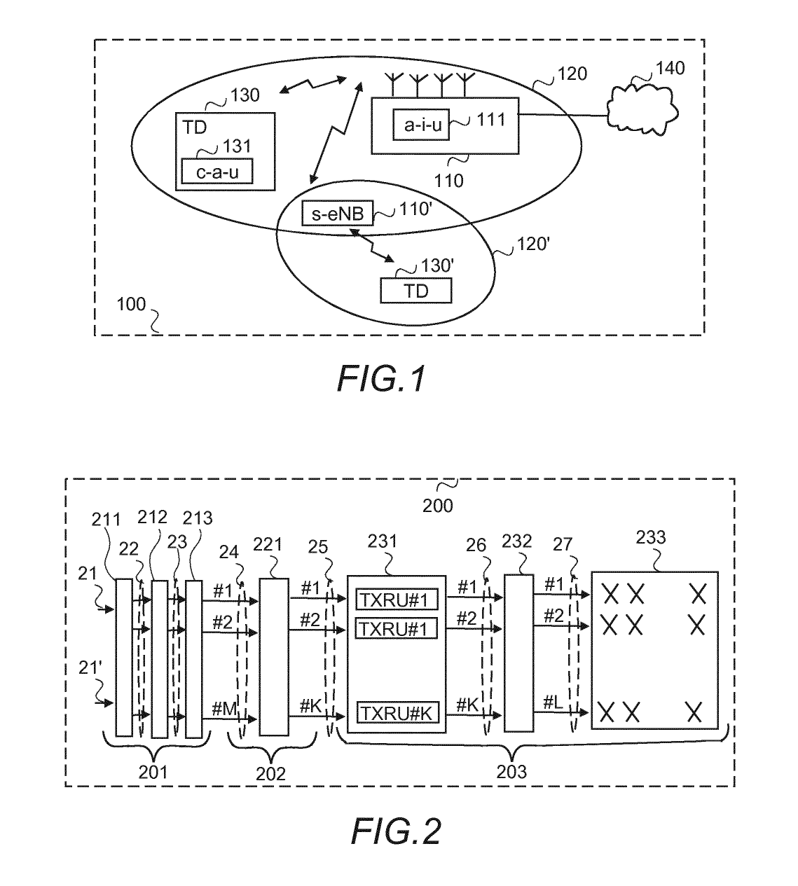

An extremely general architecture of an exemplifying system 100 to which embodiments of the invention may be applied is illustrated in FIG. 1. FIG. 1 is a simplified system architecture only showing some elements and functional entities, all being logical units whose implementation may differ from what is shown. The example illustrated in FIG. 1 employs self-backhauling, in which a network node, called an anchor network node, provides backhaul radio connection for other network nodes, called self-backhauled network nodes. A self-backhauled network node may further provide a backhaul radio connection, so that there may be a chain of self-backhauled network nodes. It is apparent to a person skilled in the art that the system may comprise any number of the illustrated elements and functional entities, and that it may be implemented without backhauling as well.

Referring to FIG. 1, a cellular communication system 100, formed by one or more cellular radio communication networks, such as the Long Term Evolution (LTE), the LTE-Advanced (LTE-A) of the 3rd Generation Partnership Project (3GPP), or the predicted future 5G solutions, are typically composed of one or more network nodes that may be of different type. An example of such network nodes is a network node providing a wide area, medium range or local area coverage for wireless apparatuses. In the illustrated example there is depicted a first network node 110 providing at least a first cell 120, and a second network node 110′ providing at least a second cell 120′, the first network node 110 depicting an anchor node and the second network 110′ node a self-backhauled node. Each or one of the network nodes 110, 110′ may further control the cell 120, 120′ it provides. A cell may be a macro cell, a micro cell, femto, or a pico cell, for example. The first network node 110 may be an evolved Node B (eNB) as in the LTE and LTE-A, or any other apparatus capable of controlling radio communication and managing radio resources within a cell. The second network node 110′ may be an evolved Node B (eNB) as in the LTE and LTE-A, or a relay or a repeater providing radio resources. For 5G solutions, the implementation may be similar to LTE-A, as described above. The first network node 110 may be called a base station or an access node because it provides the wireless apparatuses, such as terminal devices 130 and the second network node 110′, with wireless access to other networks 140 such as the Internet, either directly or via a core network (not illustrated in FIG. 1). The second network node 110′ may also be called a base station or an access node because it provides the wireless apparatuses, such as terminal devices 130′ with wireless access to other networks 140. The first network node 110 is configured to provide wireless apparatuses access information. For that purpose the network node 110 may comprise an access information unit (a-i-u) 111 configured to apply one or more of mechanisms/schemes described in more detail below with synchronization information, for example with the architecture disclosed in FIG. 2. It should be appreciated that the network node 110 is depicted to include 4 antennas only for the sake of clarity. The number of reception and/or transmission antennas may naturally vary according to a current implementation. Depending on implementation, the second network node 110′ may also be configured to provide access information, and thereby comprise the access information unit (not illustrated in FIG. 1), or it may be configured to forward the access information received from the first network node. In both cases, the second network node 110′ is configured to deploy access information sent from the first network node 110, and may comprise a cell access unit (not illustrated in FIG. 1) described below.

The terminal device 130, 130′ refers to a portable computing device (equipment, apparatus), and it may also be referred to as a user device, a user terminal or a mobile terminal or a machine-type-communication (MTC) device, also called Machine-to-Machine device and peer-to-peer device. Such computing devices (apparatuses) include wireless mobile communication devices operating with or without a subscriber identification module (SIM) in hardware or in software, including, but not limited to, the following types of devices: mobile phone, smart-phone, personal digital assistant (PDA), handset, laptop and/or touch screen computer, e-reading device, tablet, game console, notebook, multimedia device, sensor, actuator, video camera, car, refrigerator, other domestic appliances, telemetry appliances, and telemonitoring appliances. The terminal device 130, 130′ is configured to deploy access information sent from the network node 130. For that purpose the terminal device 130, 130′ may comprise a cell access unit (c-a-u) 131 (illustrated in FIG. 1 only with the first terminal device 130) configured to deploy one or more of mechanisms/schemes described in more detail below with synchronization information. The terminal device 130, 130′ may further be configured to deploy legacy access procedures, such as a legacy cell detection and cell synchronization procedure.

FIG. 2 illustrates an exemplified logical transceiver architecture 200 with which different embodiments for downlink information may be implemented in a network node configured to support AAS and MIMO, without restricting the examples to such architecture. For the sake of clarity, only downlink transmission processing is described herein; downlink reception procedure is a reversed one.

The exemplified transceiver architecture 200 comprises a digital MIMO downlink processing part 201, an antenna port virtualization part 202, and a general radio architecture part 203. The exemplified architecture 200 comprises L antenna elements, K transceiver units and M antenna ports. It should be appreciated that the antenna ports do not correspond to physical antennas, but rather are logical entities distinguished by their reference signal sequences. M, K and L may be any number starting from one, with the following restriction: M may be smaller than or equal to K, and K may be smaller than or equal to L. For example, L may be four, eight, twelve, twenty, hundred, more than thousand. MIMO may be for a single-user MIMO (SU-MIMO) or for multi-user MIMO (MU-MIMO) or cooperative MIMO (CO-MIMO).

The digital MIMO downlink processing part 201 comprises a layer mapping entity 211 that is configured to map one or more modulated codewords 21, 21′, a codeword comprising channel encoded bits originating from the same block of information bits intended for a transmission, for example, to M spatial layers 22 and to forward the spatial layers to a precoding entity 212. The precoding entity 212 is configured to precode the M spatial layers and forward the precoded M spatial layers 23 to an OFDMA (Orthogonal Frequency-Division Multiple Access) signal generation entity 213. The OFDMA signal generation entity 213 is configured to generate, from the precoded M spatial layers, M antenna port signals 24. The antenna port signals may have any waveform supporting spatial multiplexing. Examples of such waveforms that the OFDMA signal generation entity 213 may produce include DFT (discrete Fourier transform) spread OFDMA, Zero-Tail DFT spread OFDMA, filtered OFDMA, or Filter Bank based Multi-Carrier. The OFDMA signal generation entity 213 is configured to output the M antenna port signals 24 to the antenna virtualization part 202. A block 221 in the antenna virtualization part 202 is configured to map M antenna port signals to K transceiver unit (TXRU) digital signals 25 and to forward them to the general radio architecture part 203. As the name says, the general radio architecture part 203 is generic to all types of AAS structures including diversity, beam-forming, spatial multiplexing, or any combination of the three. The general radio architecture part 203 comprises K transceiver units forming a transceiver unit array 231, each transceiver unit (TXRU) being configured to receive a digital signal 24, to transform it to a corresponding radio frequency (RF) signal 26 and to forward the RF signal to a radio distribution network (RDN) block 232 for TXRU virtualisation to create L antenna signals 27 forwarded to an antenna array 233 comprising L antenna elements. In other words, the RDN block 232 distributes radio signals generated by the active transceiver unit array 231 to the antenna array 233. The distribution may be one-to-one mapping. In the illustrated example in the antenna array legs\and/forming X illustrate different polarizations.

It should be appreciated that any other way than the digital MIMO downlink processing may be used. Regardless the way how M transmission streams are created, once M transmission streams, i.e. signals 23, are received, they are fed by M antenna ports to K transceiver units (or transmitter units, if separate units are employed for transmission and reception), the K transceiver units in turn feed L antenna elements through RDN.

If the selection of antenna port is predefined, for example in a specification, the precoding entity may use different and/or the same precoders for access information, for demodulation reference symbols and for downlink data.

Below synchronization information is used as an example of access information without restricting the examples to synchronization information. Other examples of access information include system information within the cell, master system information within the cell, both being broadcasted in LTE in a physical broadcast channel, including for example parameterization (location in time-frequency resource grid) of random access channel, and channel state information, for example channel state information reference signal CSI-RS broadcasted in LTE. It should be appreciated that the above are just few examples of the access information, i.e. information needed to detect a cell, to synchronize with a cell, and to establish a connection.

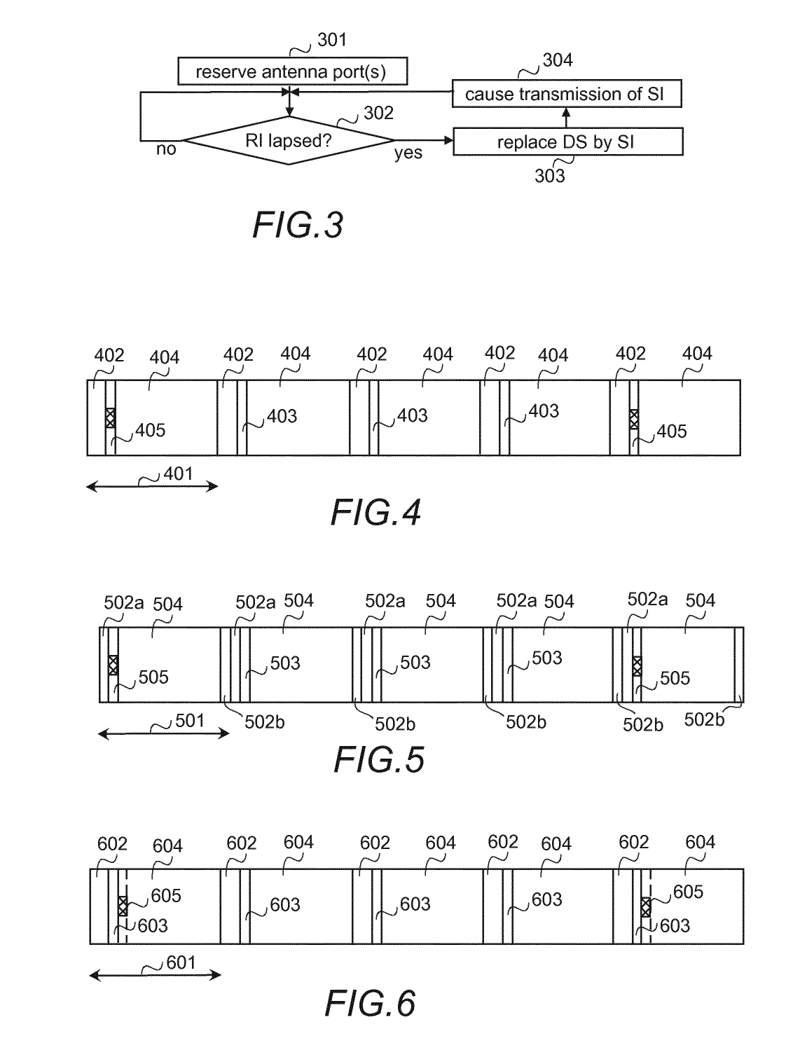

FIG. 3 is a flow chart illustrating an exemplified basic functionality of network node, or more precisely, the access information unit, to provide the synchronization information spatially embedded in downlink transmission.

Referring to FIG. 3, the process starts by reserving (block 301) at least one antenna port for transmission of synchronization information, and then the process continues by replacing (block 303) at a repetition interval (block 302) at least one downlink symbol belonging to the at least one antenna port by one or more sequences of the synchronization information, the replacing (block 303) causing (block 304) transmission of the synchronization information.

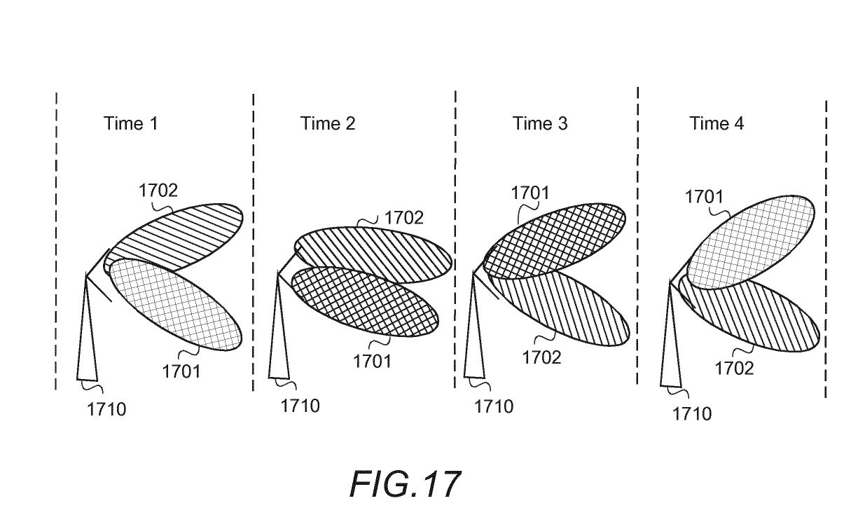

Hypothetically thinking, assuming that the synchronization information is to be composed of one synchronization sequence fitting into one resource element of a downlink symbol, although typically mapping of a synchronization sequence requires more than one resource element, one may describe the procedure illustrated in FIG. 3 as follows: after an antenna port is reserved in block 301 for transmission of synchronization information, and a repetition interval (RI) has lapsed (block 302), a synchronization sequence embedded in block 303 into a resource element of the antenna port in a subframe containing downlink data, thereby causing (block 304) transmission of the synchronization information. The synchronization sequency may be precoded before it is embedded in block 303 to beamform it to a desired spatial direction, as will be described in more detail below, for example with FIG. 17.

The repetition interval, i.e. how often the synchronization information is to be transmitted, depends on various factors including maximum data rate to be supported, target minimum time and/or target maximum time to detect a cell, how many repetitions are acceptable to achieve the targets, just to mention few factors. For example, the repetition period may be defined/set to be every kth subframe, wherein k is an integer; or the repetition interval may be given as a time, such as 5 ms or 10 ms, for example. Depending on implementation and/or purpose of use, the repetition interval may be a predefined interval or an interval that may be dynamically adjusted, or a combination of a predefined interval that may be dynamically reduced by dividing by an integer the predefined interval into smaller intervals, or dynamically enlarged by multiplying the predefined interval, and using it.

Different implementations provide embedding the access information by replacing demodulation reference symbols (DMRS) and/or by replacing downlink data symbols. In other words, at least part of downlink symbol (DMRS symbol and/or downlink data symbol) resources of one or more antenna ports is replaced by the access information, the part being dynamically configurable, thereby spatially multiplexing the access information with DMRS and/or downlink data. Herein, the term “downlink symbol” refers to the smallest physical resource (time-frequency allocation) for an antenna port that is used to transmit information in the downlink. For example, in LTE the downlink symbol would refer to one resource element transmitted in the downlink.

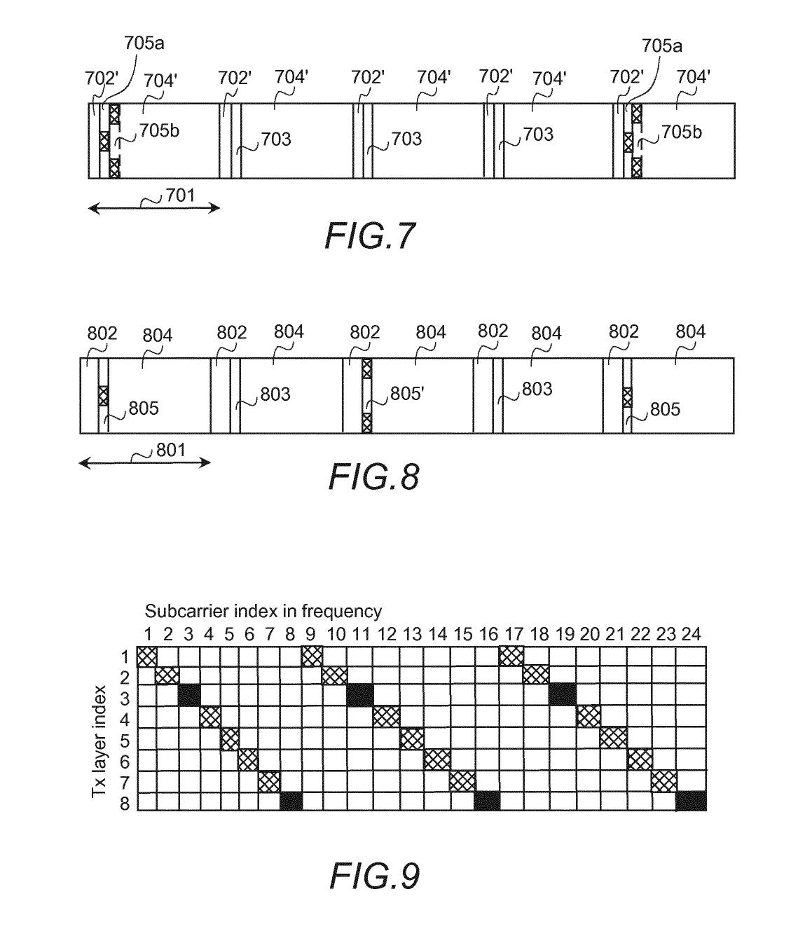

Returning back to synchronization information as an example of access information, FIGS. 4 and 5 illustrate examples of layouts of basic subframe parameterization/operation with DMRS symbol located synchronization information, the layouts showing a time-frequency resource grid for an antenna port that is reserved for transmission of synchronization information. FIG. 6 illustrates an example of a layout of basic subframe parameterization/operation with a downlink data symbol located synchronization information, the layout showing a time-frequency resource grid for an antenna port that is reserved for transmission of synchronization information. FIG. 7 illustrates a further exemplified layout of basic subframe parameterization/operation providing more versatile possibitilies, the layout showing a time-frequency resource grid for an antenna port that is reserved for transmission of synchronization information. In FIGS. 4 to 7 every fourth subframe is used as an exemplified repetition interval in time and no repetition interval in frequency is used, without restricting the examples to such solutions. It should be appreciated that any repetition interval in time may be used, as well as any repetition interval in frequency may be used.

Referring to FIG. 4, a subframe 401 in the illustrated example starts with resources 402 reserved for downlink control and/or for uplink control, then resources 403 reserved for a DMRS symbol and resources 404 reserved for data symbols that may be for downlink (DL) or uplink (UL) data. However, since one or more antenna ports have been reserved for synchronization information and the repetition interval is every fourth subframe, every fourth DMRS symbol is replaced by synchronization information 405 using some or all resources reserved for DMRS symbol.

The example illustrated in FIG. 5 differs from the one illustrated in FIG. 4 in that respect that resources for control information are reserved differently. In the example of FIG. 5, a subframe 501 comprises resources 502a reserved for downlink control, resources 503 reserved for a DMRS symbol, resources 504 reserved for data symbols that may be for downlink (DL) or uplink (UL) data, and resources 502b reserved for uplink control. However, since one or more antenna ports have been reserved for synchronization information and the repetition interval is every fourth subframe, every fourth DMRS symbol is replaced by synchronization information 505 using some or all resources reserved for DMRS symbol.

Referring to FIG. 6, a subframe 601 in the illustrated example starts with resources 602 reserved for downlink control and/or uplink control, then resources 603 reserved for a DMRS symbol and resources 604 reserved for data symbols that may in principle be for downlink (DL) or uplink (UL) data. However, since one or more antenna ports have been reserved for synchronization information and the repetition interval is in the illustrated example of FIG. 6 every fourth subframe, in at least every fourth subframe there has to be reserved resources for downlink data to replace a downlink data symbol by synchronization information 605 using some or all resources reserved for the downlink symbol.

Naturally the principles illustrated in FIG. 5 may be implemented also to the subframe illustrated in FIG. 6. In such a layout, a subframe (601) may comprise downlink control (602), DMRS (603), and either synchronization information (605) embedded in downlink data (604) or uplink and/or downlink data without synchronization information, followed by uplink control information.

In the illustrated examples of FIGS. 4 to 6, the frequency allocation for the synchronization information is neighborhood of the center of the channel bandwidth. However, that need not to be the case: different domain allocations may be used, and the synchronization information may be allocated to locate somewhere else than in the vicinity of the center of the channel bandwidth. Further, the synchronization information may be repeated in frequency and/or it may be a longer sequence to enable low-end terminal devices, which are capable of detection only part of the channel bandwidth, to detect the synchronization information.

FIG. 7 illustrates a further exemplified layout providing different possibilities for resource allocation/spatial multiplexing of the synchronization information.

Referring to FIG. 7, a subframe 701 in the illustrated example starts with resources 702′ reserved for downlink control, then resources 703 reserved for a DMRS symbol and resources 704′ reserved for downlink data symbols. However, since one or more antenna ports for DMRS symbols and one or more antenna ports for downlink data symbols have been reserved for synchronization information and the repetition interval is in the illustrated example of FIG. 7 every fourth subframe, every fourth DMRS symbol is replaced by synchronization information 705a using some or all resources reserved for DMRS symbol, and in every fourth subframe at least a downlink data symbol is replaced by synchronization information 705b using some or all resources reserved for the downlink symbol, with partial frequency domain allocation in the illustrated example.

Naturally, with a downlink data only subframe it is possible to replace either DMRS symbols (i.e. only 705a, no 705b), or downlink data symbols (i.e. no 705a, only 705b), or both, as described above. When synchronization information is embedded by replacing the data symbols 705b, corresponding DMRS symbols that are used for demodulation of synchronization information that replaces one or more data symbols may be precoded with the same precoding as the synchronization information to further improve synchronization. Additionally when other signals such as system information broadcast is transmitted in following symbols of the frame with the same precoding as the synchronization information, a terminal device may utilize channel estimation from DRMS symbols for demodulating system information broadcast signal.

By defining different repetition intervals, reserving different antenna ports, i.e. reserving more than one antenna port for synchronization information, and allocating different frequency domains it is possible to define and use different synchronization hypothesis.

Different examples will be described below using the implementation in which DMRS symbols are replaced as an exemplified implementation. However, the examples may be implemented with any downlink symbol replacement implementation, such as replacing downlink data symbols or replacing both DMRS symbols and downlink data symbols, as illustrated above with FIG. 7. The only restriction to be taken into account is that one or more downlink symbols have to occur so that once a repetition interval has lapsed, there is a downlink symbol that may be replaced. In other words, downlink resources needed for transmitting the synchronization information have to be available. When TDD frame structure is used, it is assumed that the frame, or subframe always includes DMRS thereby providing downlink resources for embedding the synchronization information to DMRS resources. However, in the TDD frame structure downlink data resources are available only in subframes carrying downlink data, and hence the repetition interval depends on the occurring frequency of the subframes carrying downlink data. The occurring frequency depends on downlink/uplink ration configured to TDD.

FIG. 8 illustrates a further exemplified layout, based on a subframe 801 having resources 802 reserved for downlink and/or uplink control information, resources 803 reserved for DMRS, and resources 804 reserved for downlink and/or uplink data symbols, with which several possible different synchronization hypothesis will be described. In a first hypothesis, every fourth DMRS symbol 803 is replaced by synchronization information 805 using some or all resources reserved for DMRS symbol. In a second hypothesis, every fourth DMRS symbol is replaced by synchronization information 805′ with partial frequency domain allocation. In a third hypothesis there is two modes, the baseline mode in which every fourth DMRS symbol is replaced by synchronization information 805 using some or all resources reserved for DMRS symbol and a “fast” mode in which every second DMRS symbol is replaced by synchronization information in such a way that every second synchronization information 805 uses some or all resources reserved for DMRS symbol and every second synchronization information 805′ is with partial frequency domain allocation. Yet another alternative include that a maximum repetition interval is defined in common specifications, then reduced repetition interval could be set via network management, for example, to be used when reduced latency is needed, for example. It should be appreciated that the above is not an exhaustive list, it simply describes some possibilities.

FIG. 9 illustrates an example in which multiple DRMS resource elements are allocated for synchronization signals in a layer wise assuming rank 8 transmission. In the illustrated example, transmission (Tx) layers 3 and 8, i.e. antenna ports 3 and 8, are reserved for synchronization information and a comb-like allocation across frequency is assumed. The black blocks in the FIG. 9 illustrate single values of synchronization sequences building the synchronization information, for example a synchronization signal. Sequences used in different layers may be equal or different and they may be precoded with the same or different precoders. The hatched blocks illustrate transmission layer wise DMRS per subcarrier. It should be appreciated that other allocations may be used as well. It is possible to transmit multiple beam-formed synchronization information by precoding the resource elements separately.

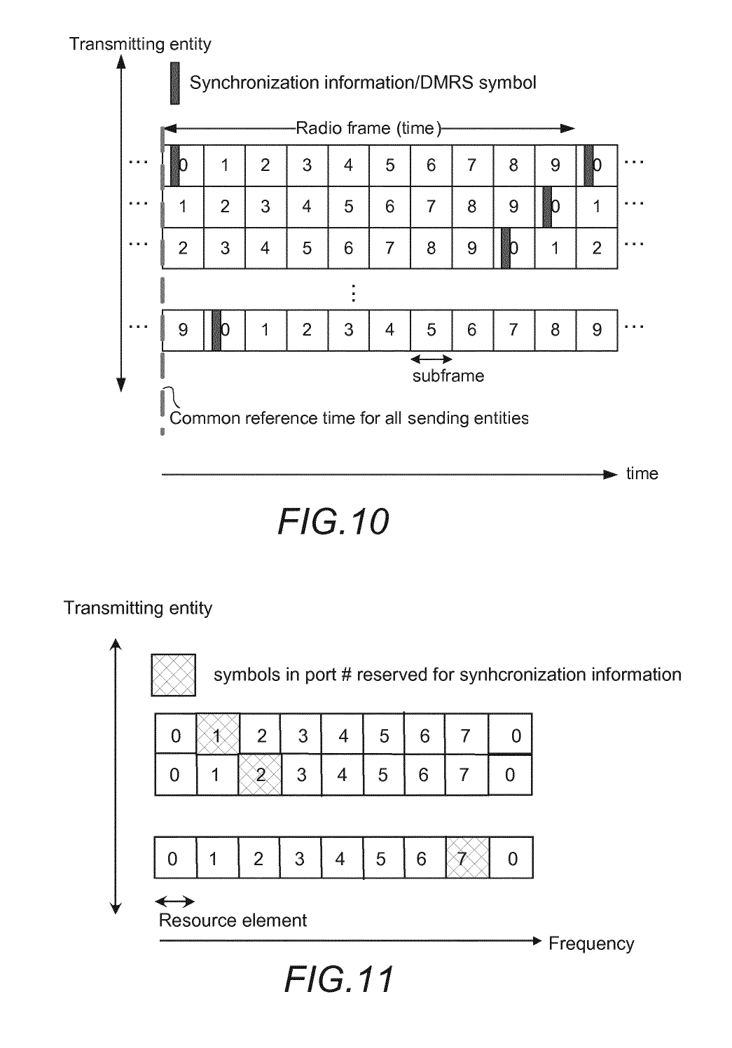

Time and/or frequency diversity can be achieved between neighboring cells by time shifting, as illustrated by an example in FIG. 10, and/or by mapping the synchronization signal to a transmitting entity specific resource element, as illustrated by an example in FIG. 11.

Referring to FIG. 10, it illustrates an example having ten subframes composing one frame. With such an arrangement, time diversity of order ten is achievable. In other words, by shifting a subframe timing in neighbouring entities, compared to a common reference time for all sending entities, time diversity of order of the number of subframes in one frame may be achieved.

Referring to FIG. 11, it is assumed that the subframe 0 of a radio frame, as illustrated in FIG. 10, is used to transmit the synchronization information. Further, in the illustrated example it is assumed that DMRS symbol supports eight spatial streams. This means that for each DMRS symbol a dedicated reference symbol sequence per stream occupies every eighth resource element from the DMRS symbol in a frequency division multiplexed manner, unless it has been replaced by synchronization information in which case a resource element is occupied by a synchronization sequence.

Using the numbers of the examples, i.e. eight spatial streams and 10 subframes per one frame, and assuming that synchronization information is provided by a synchronization signal, 80 synchronization signals may be created with orthogonal resource elements. A synchronization signal may correspond to a primary synchronization signal, or a secondary synchronization signal, or be a combination of them, for example. Further, assuming a code space of one hundred codes, it is possible to have 8000 detectable transmitting entities inside one frame. In other words, significant diversity and search space can be provided.

In other words, different transmitting network nodes, or corresponding transmitting entities, may use the time and frequency diversity to enable a receiving entity to simultaneously detect multiple transmitting entities in a reduced time window and reduced inter-cell interference between neighboring cells, compared to prior art solutions, to improve synchronization reliability whenever required. In other words, more efficient cell tracking and detection is enabled since the receiving entities, such as the terminal devices and self-backhauled network nodes, may scan the radio environment from one carrier frequency in a single radio frame. Further, the increased resource orthogonality, compared to the prior art solution, enables the receiving entities to detect also non dominant cells.

It should be appreciated that any way to divide, and control the division/allocation, the time and frequency diversity between transmitting entities may be used. For example, if there is an anchor transmitting entity and one or more backhauled transmitting entities, the anchor transmitting entity may use a specific time frequency hypothesis, such as one of the time shiftings illustrated in FIG. 10 and one of the resource elements illustrated in FIG. 11, and the anchor transmitting entity may instruct/control its backhauled transmitting entities either to use the same specific time frequency hypothesis, or a different one. Alternatively, the anchor transmitting entity and the one or more backhauled entities each select a best available time frequency hypothesis based on own measurements and measurement results received from terminal devices already connected, and the information on the best available time frequency may be transmitted between the anchor transmitting entity and a backhauled transmitting entity using higher layer signaling.

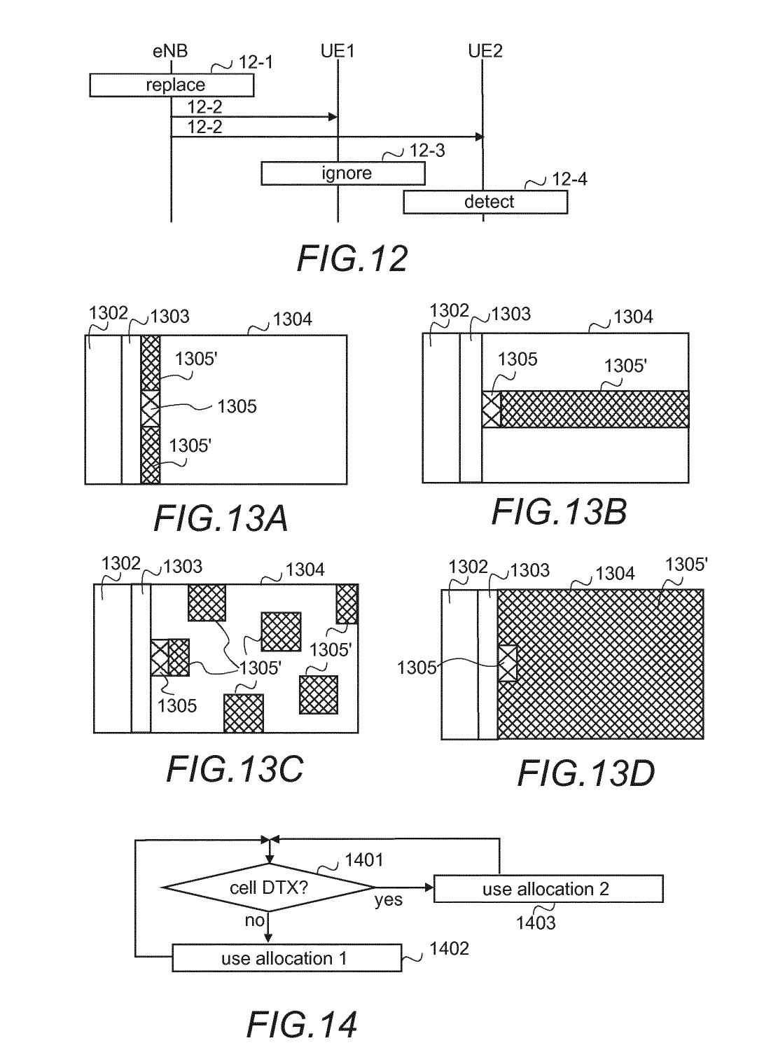

FIG. 12 illustrates transmission of the synchronization information and its use. In the illustrated example, a network node eNB transmits (or more precisely, the access information unit in eNB causes transmission) in 12-2 synchronization information by replacing (block 12-1)at least one downlink symbol belonging to at least one antenna port, reserved for synchronization information amongst plurality of antenna ports, by one or more sequences of the synchronization information. The sub-frame with the synchronization information is received by terminal devices UE1 and UE2. Since UE1 is already connected to eNB, UE1, or more precisely the cell detection and synchronization unit in UE1, ignores (block 12-3) the synchronization information. Alternatively UE1 may update and fine tune its synchronization status. However, UE2 is not connected and UE2, or more precisely the cell detection and synchronization unit in UE2, detects (block 12-4) the cell provided by eNB. UE2 may then synchronize to the cell. After the synchronization the UE2 may then receive at least master master system information broadcast over a broadcast channel to further identify cells and to enable access to the cell.

If the synchronization information of the cell is transmitted by replacing DMRS symbols, UE1 knows now through subframe index and parameterization that resource elements of specific antenna ports are reserved for synchronization. Therefore UE1, or more precisely the cell detection and synchronization unit in UE1, ignores (block 12-3) them and does not try to use these symbols for channel estimation. Alternatively UE1 may update and fine tune its synchronization status. Assuming use of layout illustrated in FIG. 11, UE2, or more precisely the cell detection and synchronization unit in UE2, is able to detect (block 12-4) multiple transmitting entities (e.g. BSs or other UEs in the case of D2D) in frequency and in time due to the multiplexing diversity obtained from mapping synchronization signals to different antenna ports and due to the relative shift in the frame timing between eNBs.

If the synchronization information of the cell is transmitted by replacing downlink data symbols, UE1, or more precisely the cell detection and synchronization unit in UE1, ignores (block 12-3) only part of downlink data symbols based on the synchronization channel parameterization defined by the used synchronization signal hypothesis, or UE1 uses them to update and fine tune its synchronization status, whereas UE2, or more precisely the cell detection and synchronization unit in UE2, is able to detect (block 12-4) the synchronization information. Assuming that synchronization information, channel state information, and physical broadcast channel are transmitted by replacing the downlink data symbols, i.e. as replacing symbols, and both DMRS symbols and the replacing symbols are precoded in the same way, UE2, searching for a cell, detects the synchronization information and is able to use a channel estimation received via DMRS symbols to decode the physical broadcast, and in the next repetition round, i.e. next time the replacing symbols are received, UE2 is able to receive the physical broadcast channel and improve the synchronization status.

Although in FIG. 12 only one transmitting entity and one transmission interval was disclosed, it is evident that a terminal device, or a backhauled network node, may receive synchronization information from several transmitting entities, as disclosed with FIG. 11, and the synchronization information is received repeatedly (periodically), i.e. at a repetition interval, as disclosed with FIG. 10.

As can be seen from the above examples, when synchronization signal is mapped on one or more certain downlink symbol, i.e. a DMRS symbol and/or downlink data symbol, on specific antenna ports, other antenna ports may use the same symbols for DMRS or data transmission. By doing so, synchronization information will be spatially multiplexed with downlink symbols thereby removing, or at least reducing, overhead of synchronization information compared to a prior art solution in which the synchronization information is sent in separate synchronization signals for which fixed physical layer resources are allocated. Yet the synchronization information is transmitted with a sufficiently small repetition interval. Further, the internal structure of the downlink control information will be simplified compared to a situation in which the synchronization information is transmitted as part of the downlink control information, and still it is possible to provide the same scheduling resolution also in subframes containing the synchronization information, as in subframes in which the synchronization information is transmitted as part of the downlink control information.

The implementation in which the synchronization signal is embedded in a downlink data channel by replacing one or more data symbols in a certain repetition interval, DMRS related channel estimation procedures are not affected. This enables further embodiments in which also a discovery channel, or corresponding discovery information may be implemented as a reparameterization of the synchronization information. FIGS. 13A to 13D illustrate different exemplified modes that may be used in the further embodiments, the modes utilizing different time-frequency allocations available. In the illustrated modes, synchronization information is repeated in a subframe by extending the synchronization information 1305 to symbols/resource elements 1305′ otherwise allocated for downlink data transmissions 1304 while maintaining resources allocated for control information 1302 and DMRS symbols 1303 intact. Thanks to the extension, a discovery channel with a high single-shot detection probability may be included. FIG. 13A illustrates a mode in which, as is shown by a more dense hatched area 1105′ in FIG. 13A, the allocation for the synchronization information is extended in frequency domain. FIG. 13B illustrates a mode in which, as is shown by a more dense hatched area 1305′ in FIG. 13B, the allocation for the synchronization information is extended in time domain. FIG. 13C illustrates a mode in which, as is shown by more dense hatched areas 1305′ in FIG. 13C, discontinuous allocations in the time-frequency grid is used to extend resources allocated for the synchronization information from downlink resources. FIG. 13D illustrates a mode in which, as is shown by a hatched area in FIG. 13D, the allocation for the synchronization information is extended to the whole downlink data channel.

The above extensions may be used also for implementations in which the DMRS symbols are replaced by synchronization information.

It should be appreciated that the FIGS. 13A to 13D illustrate antenna port—specific resource allocation. Therefore it is possible simultaneously transmit data through other antenna ports that are not reserved for synchronization information. Further, it is possible to multiplex different synchronization information through different antenna ports. If the different synchronization information is multiplexed, it is possible to use equal or different time-frequency allocation for the synchronization information in the different antenna ports. This in turn allows simultaneous transmissions of the extended synchronization information and/or discovery channel, or corresponding discovery information, to multiple beam directions within a single subframe, leading to a reduced transmission chain on time, and to a reduced energy consumption in a transceiver.

FIG. 14 is a flow chart illustrating functionality in an embodiment, in which the network node, or more precisely, the access information unit (a-i-u) is configured to take into account whether the cell is in normal mode (cell transmission mode) or in cell discontinuous transmission (DTX) mode (block 1401). If the cell is in normal mode, synchronization information is transmitted using allocation 1 (block 1402). If the cell is in DTX mode, synchronization information is transmitted using allocation 2 (block 1403). For example, the allocation 1 may be an allocation illustrated in FIG. 4 or FIG. 5, and the allocation 2 may be an allocation of one of the modes described in FIGS. 13A, 13B, 13C and 13D. Yet another example is to use the every second sub-frame sending in FIG. 8 as a normal mode transmission and the every fourth sub-frame sending in FIG. 8 in the cell discontinuous transmission. In other words, the transmissions in the cell discontinuous mode may take place less frequently than the transmission in the normal mode.

The above functionality utilizes the fact that if a cell is empty, there is no reason to limit the amount of synchronization information sent in an active subframe.

The normal mode may be a superset of the cell discontinuous transmission mode in which synchronization information is transmitted using more resources than what is used in normal mode.

It should be understood that any hypothesis/scheme for synchronization information may be used for the normal mode and/or for the cell discontinuous transmission mode.

Further, in block 1401 instead of the mode, a load and/or number of terminal devices, including self-backhauled network nodes, may be used as criteria to determine which type of parameterization, i.e. which scheme/hypothesis, is used for synchronization information and/or for discovery channel. With the parameterization it is possible to affect to cell detection probabilities, for example, to limit or increase the number of new terminal devices trying to connect to a cell.

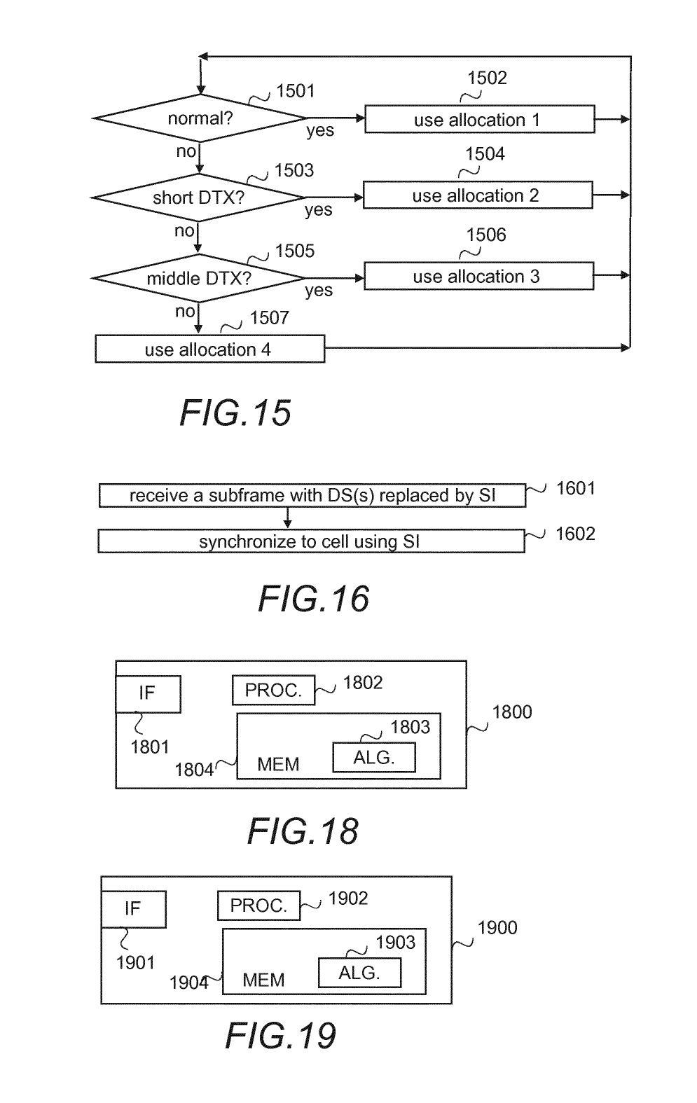

Still a further example, illustrated in FIG. 15, includes additional criteria, with which a selection between more than two allocation alternatives is performed. For example, allocation 1 (block 1502) may be used in the normal mode (block 1501), allocation 2 (block 1504) in a short DTX mode (block 1503), allocation 3 (block 1506) in a middle length DTX mode (block 1505), and allocation 4 (block 1507) for other DTX modes, which in the example may be a long DTX mode. Still a further example is as follows: allocation 1 may be used in the normal mode, allocation 2 in the short DTX mode and allocation 3 for other DTX modes. The examples simply illustrate the flexibility provided by the different schemes/hypothesis, and allocation possibilities, without restricting them to a certain amount of allocations amongst which to choose, or to a criteria used to determine which allocation is to be used. For example, load in a cell may be used as a criterium.

FIG. 16 is a flow chart illustrating an exemplified procedure on the receiving side of the synchronization information. In the illustrated example it is assumed that the terminal device has not detected a cell and is not connected to a network, for example the terminal device has just been turned on, or its flight mode turned off, without restricting the procedure to such a solution. The cell detection and synchronization starts in the illustrated example by the terminal device, or its the cell access unit, receiving (block 1601) synchronization information in a subframe in which at least one downlink symbol is replaced by one or more sequences of the synchronization information. Once the synchronization information is received, synchronization (block 1602) to the cell using the received synchronization information may take place. It should be appreciated that if the terminal device is already connected to the cell and is synchronized, the received synchronization information may be ignored or used for improving the current synchronization status, as explained above.

Naturally the terminal device, or more precisely, the cell access unit, has to have some information (pre-information) on where in a transmission frame the synchronization information is detectable. This information may be transmitted to the terminal device, for example on another frequency, or by a macro cell using a predefined and pre-agreed way to transmit its synchronization information, or via an overlapping cell using legacy synchronization information transmission mechanism. For example, the terminal device may first synchronize to an LTE cell, receive the information and use the information to detect and synchronize to a 5G cell. Yet another alternative is always to use at least one predefined allocation for the synchronization information. The predefined allocation may part of communication specifications. As can be seen the “pre-information”, such as the one or more antenna ports received for the synchronization information, and/or what constitutes a synchronization information/sequence may be delivered in any predefined way, or the terminal device, or its cell access unit may be configured to contain the information as part of its configuration.

The above described embodiments and implementations provide means for both cell and beam wise synchronization. Replacing DMRS symbols a cell wise synchronization may be achieved rather easily, replacing downlink data symbols beam wise synchronization may be achieved rather easily, and combining the both, i.e. replacing both DMRS symbols and downlink data symbols, a separate synchronization for control information and user data may be achieved to support different synchronization accuracy levels or different device categories, for example.

Selected precoding may also affect to the way the synchronization information is transmitted. Assuming that no channel dependent precoding is used and beamforming of the synchronization information is based on the narrowest beam width, in order to cover each beam direction, simultaneous transmissions into all directions in a single subframe or multiple subframes should take place. This maximizes the beamforming gain but limits usable transmission power per beam and may limit rather drastically the power remaining for data transmission. Assuming that no channel dependent precoding is used and beamforming of the synchronization information is based on a wider beam, or a beam covering the whole sector, beamforming of the synchronization information may be based on wide-band beamforming used for a broadcast downlink control channel. Assuming terminal device precoder—specific precoding of the synchronization information an improved synchronization for the terminal device may be provided.

FIG. 17 illustrates an exemplified beam-formed transmission (diamond hatch) of access information 1701 and beam-formed transmission of data 1702 (slashed hatch) at different time moments Time 1, Time 2, Time 3 and Time 4 from a transmitting entity 1710. As can be seen from FIG. 17, by using precoding the access information of the selected one or more antenna ports is beam-formed to a desired spatial direction and the data of the “unselected” antenna ports is beam-formed by precoding to another desired direction. In one embodiment, beam-formed transmission 1701 may be spatially multiplexed broadcast information that may comprise the access information and/or other broadcast information, instead of mere beamformed transmission of access information. As is evident from the above, conversion of spatial multiplexing capabilities into access opportunities in selected subframes is disclosed and different synchronization schemes, usable also for other broadcast schemes, optimizing balance between the diversifying requirements for cell detection and cell synchronization, for example, are described.

Although in the above different examples have been described assuming that the network node is a base station like network node and that the terminal device is a user equipment, implementing the teachings to other kind of solutions, such as device to device communication in which there is no base station intervention or only a limited amount of base station intervention, or to a chain of self-backhauling network nodes, is a straightforward solution for one skilled in the art.

In the above different schemes/hypothesis providing means to optimize balance between resource allocation for access information and access latency and reliability performance are disclosed.

It should be appreciated that any broadcast information may be transmitted as described above with the synchronization information as an example of access information.

The blocks and messages (i.e. information exchange) and related functions described above in FIGS. 3, 12, 14, 15 and 16 are in no absolute chronological order, and some of them may be performed simultaneously or in an order differing from the given one. Other functions can also be executed between them or within them, and other information may be sent. Some of the blocks or part of the blocks can also be left out or replaced by a corresponding block or part of the block.

The techniques described herein may be implemented by various means so that an apparatus/network node/terminal device configured to support at least one synchronization scheme/hypothesis that is at least partly based on what is disclosed above with any of FIGS. 4 to 11 and 13A to 13D, including implementing one or more functions/operations of a corresponding apparatus/network node/terminal device described above with an embodiment/example, for example by means of FIGS. 3, 12, 14, 15 and/or 16, comprises not only prior art means, but also means for implementing the one or more functions/operations of a corresponding functionality described with an embodiment, for example by means of FIG. 3, 10, 14, 15 and/or 16, and it may comprise separate means for each separate function/operation, or means may be configured to perform two or more functions/operations. For example, one or more of the means and/or the access information unit and/or the cell access unit for one or more functions/operations described above may be software and/or software-hardware and/or hardware and/or firmware components (recorded indelibly on a medium such as read-only-memory or embodied in hard-wired computer circuitry) or combinations thereof. Software codes may be stored in any suitable, processor/computer-readable data storage medium(s) or memory unit(s) or article(s) of manufacture and executed by one or more processors/computers, hardware (one or more apparatuses), firmware (one or more apparatuses), software (one or more modules), or combinations thereof. For a firmware or software, implementation can be through modules (e.g., procedures, functions, and so on) that perform the functions described herein.

FIG. 18 is a simplified block diagram illustrating some units for an apparatus 1800 configured to be a wireless access apparatus (access node) or a corresponding entity configured to provide synchronization information, comprising at least the access information unit, or configured otherwise to create and/or transmit, as described above for example by means of FIG. 3 and/or FIG. 12 and/or FIG. 14 and/or FIG. 15 and/or FIG. 16, synchronization information based on what is described above with any of FIGS. 4 to 11 and 13A to 13D, or some of the functionalities if functionalities are distributed in the future. In the illustrated example, the apparatus comprises an interface (IF) entity 1801, or more than one interface entities 1801, for receiving and transmitting information, an entity 1802, or more than one entities 1802, capable to perform calculations and configured to implement at least the synchronization unit described herein, or at least part of functionalities/operations described above, for example by means of FIG. 3 and/or FIG. 12 and/or FIG. 14 and/or FIG. 15 and/or FIG. 16, as a corresponding unit or a sub-unit if distributed scenario is implemented, with corresponding algorithms 1803, and memory 1804, or more than one memories 1804, usable for storing a computer program code required for access information unit, or a corresponding unit or sub-unit, or for one or more functionalities/operations described above, for example by means of FIG. 3 and/or FIG. 12 and/or FIG. 14 and/or FIG. 15 and/or FIG. 16, i.e. the algorithms for implementing the functionality/operations described above by means of FIG. 3 and/or FIG. 12 and/or FIG. 14 and/or FIG. 15 and/or FIG. 16. The memory 1804 is also usable for storing other possible information, like different allocation schemes, conditions when to use what allocation scheme, etc. The interface entity 1801 may be a radio interface entity, for example a remote radio head, providing the apparatus with capability for radio communications. The entity 1802 may be a processor, unit, module, etc. suitable for carrying out embodiments or operations described above, for example by means of FIG. 3 and/or FIG. 12 and/or FIG. 14 and/or FIG. 15 and/or FIG. 16. Further, a combination of the memory 1804, one or more algorithms 1803, the entity 1802 and the interface entity are further configured to provide plurality of antenna ports for data transmissions, for example as described with FIG. 2.

FIG. 19 is a simplified block diagram illustrating some units for an apparatus 1900 configured to be a wireless apparatus (device) or a corresponding entity configured to monitor and use, when needed, synchronization information transmitted from a wireless access apparatus, comprising at least the cell access unit, or configured otherwise to detect and/or use or ignore, as described above for example by means of FIG. 12 and/or FIG. 16, synchronization information based on what is described above with any of FIGS. 4 to 11 and 13A to 13D, or some of the functionalities if functionalities are distributed in the future. In the illustrated example, the apparatus comprises an interface (IF) entity 1901, or more than one interface entities 1901, for receiving and transmitting information, an entity 1902, or more than one entities 1902, capable to perform calculations and configured to implement at least the cell access unit described herein, or at least part of functionalities/operations described above, for example by means of FIG. 12 and/or FIG. 16, as a corresponding unit or a sub-unit if distributed scenario is implemented, with corresponding algorithms 1903, and memory 1904, or more than one memories 1904, usable for storing a computer program code required for the cell access unit, or a corresponding unit or sub-unit, or for one or more functionalities/operations described above, for example by means of FIG. 12 and/or FIG. 16, i.e. the algorithms for implementing the functionality/operations described above by means of FIG. 12 and/or FIG. 16. The memory 1904 is also usable for storing other possible information. The interface entity 1901 may be a radio interface entity, for example a remote radio head, providing the apparatus with capability for radio communications. The entity 1902 may be a processor, unit, module, etc. suitable for carrying out embodiments or operations described above, for example by means of FIG. 12 and/or FIG. 16.

In other words, an apparatus configured to transmit, and/or an apparatus configured to receive synchronization information based on what is described above with any of FIGS. 4 to 11 and 13A to 13D, is a computing device that may be any apparatus or device or equipment or node configured to perform one or more of corresponding apparatus functionalities described with an embodiment/example above, for example by means of FIG. 3 and/or FIG. 12 and/or FIG. 14 and/or FIG. 15 and/or FIG. 16 and it may be configured to perform functionalities from different embodiments/examples. The access information unit and/or the cell access unit, as well as corresponding units and sub-unit and other units, and/or entities described above with an apparatus may be separate units, even located in another physical apparatus, the distributed physical apparatuses forming one logical apparatus providing the functionality, or integrated to another unit in the same apparatus.

An apparatus configured to transmit, and/or an apparatus configured to receive synchronization information based on what is described above with any of FIGS. 4 to 11 and 13A to 13D, may generally include a processor, controller, control unit, micro-controller, or the like connected to a memory and to various interfaces of the apparatus. Generally the processor is a central processing unit, but the processor may be an additional operation processor. Each or some or one of the units/sub-units and/or algorithms for functions/operations described herein, for example by means of FIG. 3 and/or FIG. 12 and/or FIG. 14 and/or FIG. 15 and/or FIG. 16, may be configured as a computer or a processor, or a microprocessor, such as a single-chip computer element, or as a chipset, including at least a memory for providing storage area used for arithmetic operation and an operation processor for executing the arithmetic operation. Each or some or one of the units/sub-units and/or algorithms for functions/operations described above, for example by means of FIG. 3 and/or FIG. 12 and/or FIG. 14 and/or FIG. 15 and/or FIG. 16, may comprise one or more computer processors, application-specific integrated circuits (ASIC), digital signal processors (DSP), digital signal processing devices (DSPD), programmable logic devices (PLD), field-programmable gate arrays (FPGA), and/or other hardware components that have been programmed and/or will be programmed by downloading computer program code (one or more algorithms) in such a way to carry out one or more functions of one or more embodiments/examples. An embodiment provides a computer program embodied on any client-readable distribution/data storage medium or memory unit(s) or article(s) of manufacture, comprising program instructions executable by one or more processors/computers, which instructions, when loaded into an apparatus, constitute the guard band adjusting unit or an entity providing corresponding functionality. Programs, also called program products, including software routines, program snippets constituting “program libraries”, applets and macros, can be stored in any medium and may be downloaded into an apparatus. In other words, each or some or one of the units/sub-units and/or the algorithms for one or more functions/operations described above, for example by FIG. 3 and/or FIG. 12 and/or FIG. 14 and/or FIG. 15 and/or FIG. 16, may be an element that comprises one or more arithmetic logic units, a number of special registers and control circuits.

Further, an apparatus configured to transmit, and/or an apparatus configured to receive synchronization information based on what is described above with any of FIGS. 4 to 11 and 13A to 13D, may, may generally include volatile and/or non-volatile memory, for example EEPROM, ROM, PROM, RAM, DRAM, SRAM, double floating-gate field effect transistor, firmware, programmable logic, etc. and typically store content, data, or the like. The memory or memories may be of any type (different from each other), have any possible storage structure and, if required, being managed by any database management system. In other words, the memory may be any computer-usable non-transitory medium within the processor, or corresponding entity suitable for performing required operations/calculations, or external to the processor or the corresponding entity, in which case it can be communicatively coupled to the processor or the corresponding entity via various means. The memory may also store computer program code such as software applications (for example, for one or more of the units/sub-units/algorithms) or operating systems, information, data, content, or the like for the processor or the corresponding entity to perform steps associated with operation of the apparatus in accordance with examples/embodiments. The memory, or part of it, may be, for example, random access memory, a hard drive, or other fixed data memory or storage device implemented within the processor/apparatus or external to the processor/apparatus in which case it can be communicatively coupled to the processor/network node via various means as is known in the art. Examples of an external memory include a removable memory detachably connected to the apparatus, a distributed database and a cloud server.

An apparatus configured to transmit, and/or an apparatus configured to receive synchronization information based on what is described above with any of FIGS. 4 to 11 and 13A to 13D, may generally comprise different interface units, such as one or more receiving units and one or more sending units. The receiving unit and the transmitting unit each provides an interface entity in an apparatus, the interface entity including a transmitter and/or a receiver or any other means for receiving and/or transmitting information, and performing necessary functions so that the information, etc. can be received and/or sent, for example as described by means of FIG. 2. The receiving and sending units/entities may be remote to the actual apparatus and/or comprise a set of antennas, the number of which is not limited to any particular number.

It will be obvious to a person skilled in the art that, as the technology advances, the inventive concept can be implemented in various ways. The invention and its embodiments are not limited to the examples described above but may vary within the scope of the claims.

1. A method comprising:
reserving for access information at least one antenna port amongst plurality of antenna ports; and
causing transmission of the access information by replacing at a repetition interval at least one downlink symbol belonging to the at least one antenna port by one or more sequences of the synchronization information.

2-12. (canceled)

13. An apparatus comprising:
an antenna set;
at least one processor and at least one memory including a computer program code, the at least one memory and the computer program code configured to, with the at least one processor and the antenna set, cause the apparatus at least to:
provide plurality of antenna ports; and
cause transmission of access information by replacing at a repetition interval at least one downlink symbol belonging to at least one antenna port, reserved for access information amongst the plurality of antenna ports, by one or more sequences of the access information.

14. The apparatus of claim 13, further comprising causing the apparatus to time shift the transmission of the access information.

15. The apparatus of claim 13, further comprising causing the apparatus to frequency map the transmission of the access information.

16. The apparatus of claim 13, wherein the at least one downlink symbol is a one of a demodulation reference symbol and a downlink data symbol.

17. The apparatus of claim 13, further comprising causing the apparatus to replace at least a demodulation reference symbol and a downlink data symbol belonging to the at least one antenna port by the one or more sequences of the access information.

18. The apparatus of claim 13, further comprising causing the apparatus to use, in response to a cell discontinuous transmission, another repetition interval than in a cell transmission mode.

19. The apparatus of claim 13, further comprising causing the apparatus to allocate further resources for access information from resources belonging to the at least one antenna port and allocated for downlink data.

20. The apparatus of claim 19, further comprising causing the apparatus to use, in response to a cell discontinuous transmission, the further resources for access information.

21. The apparatus of claim 13, further comprising causing the apparatus to receive access information in a subframe in which at least one downlink symbol is replaced by one or more sequences of the access information.

22. An apparatus comprising:
at least one processor and at least one memory including a computer program code, the at least one memory and the computer program code configured to, with the at least one processor, cause the apparatus at least to receive access information in a subframe in which at least one downlink symbol is replaced by one or more sequences of the access information.

23. (canceled)

24. The apparatus of claim 22, further comprising a radio interface entity providing the apparatus with capability for radio communications.

25. The apparatus of any of claim 13, wherein the access information is synchronization information.

26. The apparatus of claim 13, wherein one downlink symbol is the smallest physical resource in time-frequency allocation for one antenna port used to transmit information in downlink.

27. A non-transitory computer readable media having stored thereon instructions that, when executed by a computing device, cause the computing device to:
reserve for access information at least one antenna port amongst plurality of antenna ports; and
cause transmission of the access information by replacing at a repetition interval at least one downlink symbol belonging to the at least one antenna port by one or more sequences of the access information.

28. (canceled)
